SEQUENCE LISTING (3 sequences)

SEQ ID NO: 1 - DNA, 2061 bp, Bacillus stearothermophilus
  CDS (1)..(2061)
agcagttccgcaagcgtcaaaggggacgtgatttaccagattatcattgaccggttttacgatggggacacgacgaacaacaatcctgccaaaagttatggactttacgatccgaccaaatcgaagtggaaaatgtattggggcggggatctggagggggttcgtcaaaaacttccttatcttaaacagctgggcgtaacgacaatctggttgtccccggttttggacaatctggatacactggcgggcaccgataacacgggctatcacggatactggacgcgcgattttaaacagattgaggaacatttcgggaattggaccacatttgacacgttggtcaatgatgctcaccaaaacggaatcaaggtgattgtcgactttgtgcccaatcattcgactccttttaaggcaaacgattccacctttgcggaaggcggcgccctctacaacaatggaacctatatgggcaattattttgatgacgcaacaaaagggtacttccaccataatggggacatcagcaactgggacgaccggtacgaggcgcaatggaaaaacttcacggatccagccggtttctcgcttgccgatttgtcgcaggaaaatggcacgattgctcaatacctgaccgatgcggcggttcaattggtagcacatggagcggatggtttgcggattgatgcggtgaagcattttaattcggggttctccaaatcgttggccgataaactgtaccaaaagaaagacattttcctggtgggggaatggtacggagatgaccccggaacagccaatcatctggaaaaggtccggtacgccaacaacagcggtgtcaatgtgctggattttgatctcaacacggtgattcgaaatgtgttcggcacatttacgcaaacgatgtacgatcttaacaatatggtgaaccaaacggggaacgagtacaaatacaaagaaaatctaatcacatttatcgataaccatgatatgtcaagatttctttcggtaaattcgaacaaggcgaatttgcaccaggcgcttgctttcattctcacttcgcggggtacgccctccatctattatggaaccgaacaatacatggcaggcggcaatgacccgtacaaccgggggatgatgccggcgtttgatacgacaaccaccgcctttaaagaggtgtcaactctggcggggttgcgcaggaacaatgcggcgatccagtacggcaccaccacccagcgttggatcaacaatgatgtttacatttatgaacggaaatttttcaacgatgtcgtgttggtggccatcaatcgaaacacgcaatcctcctattcgatttccggtttgcagacggccttgccaaatggcagctatgcggattatctgtcagggctgttgggggggaacgggatttccgtttccaatggaagtgtcgcttcgttcacgcttgcgcctggagccgtgtctgtttggcagtacagcacatccgcttcagcgccgcaaatcggatcggttgctccaaatatggggattccgggtaatgtggtcacgatcgacgggaaaggttttgggacgacgcagggaaccgtgacatttggcggagtgacagcgactgtgaaatcctggacatccaatcggattgaagtgtacgttcccaacatggccgccgggctgaccgatgtgaaagtcaccgcgggtggagtttccagcaatctgtattcttacaatattttgagtggaacgcagacatcggttgtgtttactgtgaaaagtgcgcctccgaccaacctgggggataagatttacctgacgggcaacataccggaattggggaattggagcacggatacgagcggagccgttaacaatgcgcaagggcccctgctcgcgcccaattatccggattggttttatgtattcagcgttccagcaggaaagacgattcaattcaagttcttcatcaagcgtgcggatggaacgattcaatgggagaatggttcgaaccacgtggccacaactcccacgggtgcaaccggtaacattactgttacgtggcaaaactag

SEQ ID NO: 2 - protein, 686 aa, Bacillus stearothermophilus
SSSASVKGDVIYQIIIDRFYDGDTTNNNPAKSYGLYDPTKSKWKMYWGGDLEGVRQKLPYLKQLGVTTIWLSPVLDNLDTLAGTDNTGYHGYWTRDFKQIEEHFGNWTTFDTLVNDAHQNGIKVIVDFVPNHSTPFKANDSTFAEGGALYNNGTYMGNYFDDATKGYFHHNGDISNWDDRYEAQWKNFTDPAGFSLADLSQENGTIAQYLTDAAVQLVAHGADGLRIDAVKHFNSGFSKSLADKLYQKKDIFLVGEWYGDDPGTANHLEKVRYANNSGVNVLDFDLNTVIRNVFGTFTQTMYDLNNMVNQTGNEYKYKENLITFIDNHDMSRFLSVNSNKANLHQALAFILTSRGTPSIYYGTEQYMAGGNDPYNRGMMPAFDTTTTAFKEVSTLAGLRRNNAAIQYGTTTQRWINNDVYIYERKFFNDVVLVAINRNTQSSYSISGLQTALPNGSYADYLSGLLGGNGISVSNGSVASFTLAPGAVSVWQYSTSASAPQIGSVAPNMGIPGNVVTIDGKGFGTTQGTVTFGGVTATVKSWTSNRIEVYVPNMAAGLTDVKVTAGGVSSNLYSYNILSGTQTSVVFTVKSAPPTNLGDKIYLTGNIPELGNWSTDTSGAVNNAQGPLLAPNYPDWFYVFSVPAGKTIQFKFFIKRADGTIQWENGSNHVATTPTGATGNITVTWQN

SEQ ID NO: 3 - protein, 621 aa, Rhodothermus obamensis
MSWLTEEDIRRWESGTFYDSYRKLGAHPDDEGTWFCVWAPHADGVSVLGAFNDWNPEANPLERYGGGLWAGYVPGARPGHTYKYRIRHGFYQADKTDPYAFAMEPPTGSPIEGLASIITRLDYTWHDDEWMRRRKGPASLYEPVSIYEVHLGSWRHKRPGESFSYREIAEPLADYVQEMGFTHVELLPVMEHPYYGSWGYQVVGYYAPTFRYGSPQDLMYLIDYLHQRGIGVILDWVPSHFAADPQGLVFFDGTTLFEYDDPKMRYHPDWGTYVFDYNKPGVRNFLISNALFWLEKYHVDGLRVDAVASMLYRDYSRKEWTPNIFGGRENLEAIDFIKKFNETVYLHFPEAMTIAEESTAWPGVSAPTYNNGLGFLYKWNMGWMHDTLDYIQRDPIYRKYHHDELTFSLWYAFSEHYVLPLSHDEVVHGKGSLWGKMPGDDWQKAANLRLLFGHMWGHPGKKLLFMGGEFGQHHEWNHDTQLEWHLLDQPYHRGIQLWVCDLNHLYRTNPALWHDGPEGFEWIDFSDRDQSVICYLRKNAGRMLLFVLNFTPVPREHYRVGVPIGGPWHEVLNSDAVAYGGSGMGNFGRVEAVPESWHGRPFHLELTLPPLAALILEPEHG

(19) United States
(12) Patent Application Publication
(10) Pub. No.: US 2015/0173402 A1
(43) Pub. Date: Jun. 25, 2015

(54) RICE COOKING METHOD

(71) Applicant: Novozymes A/S, Bagsvaerd (DK)

(72) Inventor: Noriyuki Nakashima, Kanagawa (JP)

(73) Assignee: Novozymes A/S, Bagsvaerd (DK)

(21) Appl. No.: 14/405,850

(22) PCT Filed: Jun. 25, 2013
(86) PCT No.: PCT/EP2013/063308

§ 371 Date: Dec. 5, 2014

(30) Foreign Application Priority Data
Jun. 27, 2012 (EP) 12173793.6

(51) Int. Cl. A23L 1/105; A23L 1/182

(52) U.S. Cl. CPC A23L 1/1055; A23L 1/1826; A23V 2002/00

(57) ABSTRACT

The present invention relates to a method for preparing cooked rice having retarded staling. Specifically, the present invention relates to a method for preparing boiled rice foods having a improved texture following storage for up to several days.

### FIELD OF THE INVENTION

The present invention relates to a method for preparing cooked rice having retarded staling. Specifically, the present invention relates to a method for preparing boiled rice foods having a improved texture following storage.

### BACKGROUND OF THE INVENTION

Cooked rice are used in a number of popular ready prepared foods sold at food stalls and convenient stores, e.g., Japanese style products, such as sushi such as maki and nigiri, rice balls such as “Onigiri” or “Omusubi”. To appeal to the customers such cooked rice products must be of a consistent quality and retain this quality until consumption.

However, when allowed to stand at room temperature or refrigerated cooked rice hardens over time. In order to prevent this deterioration of boiled rice, attempts have been made which utilize methods such as adding enzymes e.g., alpha-amylase, beta-amylase, glucoamylase, glucose oxidase, pectinase, trehalose transglutaminase and protease (EP 1108366, EP 2340732).

A number of reports have been made on the use of maltogenic alpha-amylase in breads and it is known that maltogenic alpha-amylase has an effect of improving shelf life of bread and other leavened baked products (WO 1991/04669).

However, cooked rice is a food that is completely different from bread and, therefore, the effect achieved by adding maltogenic alpha-amylase to cooked rice would largely be expected to differ from those achieved by adding the same to bread.

The object of the present invention is to provide boiled rice foods having improved texture following storage at room temperature or refrigeration for up to several days.

### SUMMARY OF THE INVENTION

As a result of intensive study to solve the object described above, the present inventors has found that by applying i.a. a maltogenic alpha-amylase or a branching enzyme, the deterioration in the quality of boiled rice foods with respect to texture caused by storage, can be prevented to a far greater extent than that achieved by the conventional method.

Accordingly, the invention provides a method for preparing cooked rice having retarded staling which comprises the steps of: (a) contacting rice with an aqueous solution of an enzyme selected from the group consisting of maltogenic alpha-amylase, branching enzyme and mixtures thereof; and (b) cooking the rice. Also provided is a cooked rice product prepared by the method of the invention.

### DETAILED DESCRIPTION OF THE INVENTION

The rice applied in the method of the present invention may be any rice species and any variety suitable for production of cooked rice. Preferred are rice of Oryza sp. or Zizania sp, preferably any of Oryza sativa (Asian rice) or O. glaberrima (African rice), Zizania aquatica (Wild rice), Z. palustris (Northern wild rice), and Z. latifolia (Manchurian wild rice). Most preferred is rice of Oryza sativa subsp. japonica and subsp. indica. Most preferably the rice is polished rice. However, the method may equally be applied in production of any dehulled cereal grain including but not limited to any of barley, wheat and rye.

The term “retarded staling” indicates a detectable reduction in hardness and/or stickiness following storage for up to 12 hours, up to 24 hours, up to 36 hours or even up to 48 hours (2 days) or longer. The reduction in hardness may be determined by use of a Texture Analyzer as described in the Materials and Methods section. The reduction in hardness after 1 day and/or after 2 days is preferably at least 5%, 10%, 15%, 20% or even 25% relative to control.

The term “maltogenic alpha-amylase” includes amylases within EC 3.2.1.133. The maltogenic alpha-amylase catalyzes hydrolysis of (1→4)-a-D-glucosidic linkages in polysaccharides so as to remove successive a-maltose residues from the non-reducing ends of the chains.

The maltogenic alpha-amylase may be derived from Bacillus stearothermophilus, e.g. strain NCIB 11837 described in EP 120693, or it may be a variant described in WO 1999/043794, WO 2006/032281 or WO 2008/148845.

The maltogenic alpha-amylase may be derived from Alicyclobacillus pohliae, e.g. from strain NCIMB 14276 described in Imperio et al. (2008) Int J Syst Evol Microbiol 58, 221-225. The maltogenic alpha-amylase may be the enzyme disclosed in U.S. Pat. No. 8,426,182.

The maltogenic alpha-amylase preparation may be obtained from a strain of B. stearothermophilus, or from a genetically manipulated strain of a suitable bacterial production organism.

Preferably the maltogenic alpha-amylase has an amino acid sequence that is at least 75%, at least 80%, at least 85%, at least at least 90%, at least 95%, at least 96%, at least 97%, at least 98%, at least 99%, or even 100% identical to the amino acid sequence in SEQ ID NO: 2.

The maltogenic alpha-amylase is typically used at a dosage of 200-50000 MANU per kg of dry solids in the rice, particularly 500-10000 MANU/kg.

The term “branching enzyme” includes enzymes within E.C. 2.4.1.18. The branching enzyme transfers a segment of a (1→4)-α-D-glucan chain to a primary hydroxy group in a similar glucan chain.

The branching enzyme may be derived from of Rhodothermus obamensis, or R. marinus such as the branching enzyme disclosed as SEQ ID NO: 2 in WO 2000/58445. Preferably the branching enzyme has an amino acid sequence that is at least 75%, at least 80%, at least 85%, at least at least 90%, at least 95%, at least 96%, at least 97%, at least 98%, at least 99%, or even 100% identical to SEQ ID NO: 3 (identical to SEQ ID NO: 2 in WO 2000/58445).

Other suitable branching enzymes may be derived from Aquifex aeolicus such as the branching enzyme disclosed in SEQ ID NO: 1 in JP 2000316581 or from Bacillus stearothermophilus such as the branching enzyme disclosed in EP 418945.

The rice may be soaked before cooking. The length of the soaking step may be between 10 minutes and 24 hours, preferably between 1 and 12 hours. The soaking step may preferably be performed at a temperature between 5 and 30° C., such as e.g., at a temperature of around 20° C.

In the method for producing the cooked rice food according to the invention, any conventional cooking process can be used, e.g., soaking rice in water, and boiling it in a lidded pot, a rice cooker, or a rice boiler.

Rice may be cooked by heating in boiling water or steam, or a combination (boiling until water evaporates, then continuing in steam generated by continued heating). Cooking may be performed at atmospheric or elevated pressure. During cooking the rice absorbs a great deal of water in the process, expanding its volume and using up the cooking water. The cooking time for raw rice (not parboiled) ranges from about 15 minutes up to 1 hour, depending upon type and freshness of rice, and rice cooking equipment used.

The treatment of rice with enzyme(s) may be conducted at any stage prior to cooking, during cooking or after cooking of the rice. Namely, the enzyme(s) may be added to soaking water in which rice is to be soaked to absorb water. Alternatively, the enzyme(s) may be added at a point between soaking and cooking.

In an embodiment, the boiled rice food of the present invention may further contain edible acetic acid and/or edible oils. Conventional vinegar is preferably used. Edible acetic acid may be added in an amount of 0.1 to 5% by weight, preferably 0.5 to 4% by weight, more preferably 1 to 3% by weight relative to raw rice. Edible oils may be added in an amount of 0.1 to 5% by weight, preferably 0.5 to 4% by weight, more preferably 1 to 3% by weight relative to the amount of raw rice. The edible acetic acid and/or edible oils may be added before, during or after cooking.

When the enzyme(s) is applied as defined above, it is possible to produce a cooked rice food which has excellent qualities immediately after the production and suffers from less degradation in the qualities with the passage of time.

The Additional Enzymes

Optionally, one or more additional enzymes may be used together with the maltogenic alpha-amylase in the method of the invention. The additional enzymes include amylase, glucanase, galactanase, mannanase, aminopeptidase, alpha-amylase, beta-amylase, carboxypeptidase, catalase, chitinase, cutinase, cyclodextrin glycosyltransferase, deoxyribonuclease, esterase, alpha-galactosidase, beta-galactosidase, glucoamylase, alpha-glucosidase, beta-glucosidase, hemicellulase, haloperoxidase, invertase, laccase, lipase, phospholipase, mannosidase, oxidase, pectinolytic enzymes, peptidoglutaminase, peroxidase, phytase, glucose oxidase, polyphenoloxidase, protease, ribonuclease, trehalose and transglutaminase. Glucoamylases suitable for use in the present invention include glucoamylases having a sequence identity of at least 50%, at least 60%, at least 65%, at least 70%, at least 75%, at least 80%, at least 85%, at least 90%, at least 95%, at least 96%, at least 97%, at least 98%, or at least 99% to the amino acid sequence of the A. niger G1 or G2 glucoamylase (Boel et al. (1984), EMBO J. 3 (5), p. 1097-1102), the A. awamori glucoamylase disclosed in WO 1984/02921, or the A. oryzae glucoamylase (Agric. Biol. Chem. (1991), 55 (4), p. 941-949).

The alpha-amylase may be fungal or bacterial, e.g., an alpha-amylase from Bacillus, e.g., B. licheniformis or B. amyloliquefaciens, a beta-amylase, e.g., from plant (e.g., soy bean) or from microbial sources (e.g., Bacillus), a glucoamylase, e.g., from A. niger, or a fungal alpha-amylase, e.g., from A. oryzae. Suitable commercial fungal alpha-amylase compositions include, e.g., BAKEZYME® P 300 (available from DSM) and FUNGAMYL® 2500 SG, FUNGAMYL® 4000 BG, FUNGAMYL® 800 L, FUNGAMYL® ULTRA BG and FUNGAMYL® ULTRA SG (available from Novozymes A/S).

The amylase may be a non-maltogenic exo-amylase (glucan 1,4-alpha-maltotetrahydrolase (EC 3.2.1.60)), e.g., one derived from Pseudomonas saccharophilia and variants thereof such as disclosed in WO 1999/050399, WO 2004/111217 and WO 2005/003339. Suitable commercial non-maltogenic exo-amylases include POWERFRESH® G4 and POWERFRESH® G+.

The glucose oxidase may be a fungal glucose oxidase, in particular an Aspergillus niger glucose oxidase (such as GLUZYME®, available from Novo Nordisk A/S, Denmark).

The hemicellulase may be a pentosanase, e.g., a xylanase which may be of microbial origin, e.g., derived from a bacterium or fungus, such as a strain of Aspergillus, in particular of A. aculeatus, A. niger, A. awamori, or A. tubigensis, from a strain of Trichoderma, e.g., T. reesei, or from a strain of Humicola, e.g., H. insolens. Suitable commercially available xylanase preparations for use in the present invention include PENTOPAN® MONO BG and PENTOPAN® 500 BG (available from Novozymes), GRINDAMYL® POWERBAKE (available from Danisco), and BAKEZYME® BXP 5000 and BAKEZYME® BXP 5001 (available from DSM).

The protease may be from Bacillus, e.g., B. amyloliquefaciens.

The phospholipase may have phospholipase A1, A2, B, C, or D activity; it may or may not have lipase activity and it may or may not have galactolipase activity. It may be of animal origin, e.g., from pancreas, snake venom or bee venom, or it may be of microbial origin, e.g., from filamentous fungi, yeast or bacteria, such as Aspergillus or Fusarium, e.g., A. niger, A. oryzae or F. oxysporum. A lipase/phospholipase from Fusarium oxysporum is disclosed in WO 1998/26057. Also, the variants described in WO 2000/32758 may be used. A porcine pancreatic phospholipase A2 is shown in SEQ ID NO: 2 herein. Suitable phospholipase A2 compositions are LIPOPAN® F and LIPOPAN® XTRA (available from Novozymes) or PANAMORE® GOLDEN and PANAMORE® SPRING (available from DSM).

The additional enzyme may be of any origin, including mammalian and plant, and preferably of microbial (bacterial, yeast or fungal) origin and may be obtained by techniques conventionally used in the art.

Use of Cooked Rice

The cooked rice prepared according to the to the invention may be used for producing any kind of rice based ready prepared foods, e.g., sushi such as maki and nigiri, rice balls such as onigiri or omusubi, lunch box such as bento and eki ben etc. Furthermore, the invention includes in its scope cooked rice products produced by freezing, aseptic-packing, retort pouch-packing, drying or canning these foods.

In a preferred embodiment the rice is Oryza sativa subsp. Japonica, the maltogenic alpha-amylase has an amino acid sequence that is at least 95% identical to the amino acid sequence in SEQ ID NO: 2, the rice is soaked in the aqueous enzyme solution before cooking in the soaking water. The reduction obtained in hardness after 1 day and/or after 2 days is at least 10% relative to control.

### EXAMPLES

Materials and Methods

Determination of Maltogenic Alpha-Amylase Activity

One MANU (Maltogenic Amylase Novo Unit) may be defined as the amount of enzyme required to release one μmol of maltose per minute at a concentration of 10 mg of maltotriose substrate (≧95% pure, e.g., Sigma M 8378) per ml of 0.1 M citrate buffer, pH 5.0 at 37° C. for 30 minutes.

Determination of Branching Enzyme Activity

The branching enzyme activity may be determined as described in EP 418 945.

Texture Analysis

Texture analysis of single rice kernels was performed using a TA-XT2i (SMS) with 90% compression of the rice kernel, Probe: 10 mm diameter cylinder (delrin). Pre-test speed: 1 mm/sec, Test speed: 0.2 mm/sec, Post-test speed: 0.2 mm/sec.

Enzymes

An enzyme preparation comprising a maltogenic alpha-amylase from B. stearothermophilus, having the amino acid sequence shown in SEQ ID NO: 2. The enzyme preparation had an activity of 10000 MANU/g.

An enzyme preparation comprising a branching enzyme derived from of Rhodothermus obamensis having the amino acid sequence shown in to SEQ ID NO: 3 (identical to SEQ ID NO: 2 in WO 2000/58445).

### Example 1

Procedure of the Test: 160 g of uncooked rice (Oryza sativa subsp. japonica) was washed in tap water and soaked in 190 ml water or 190 ml water with enzyme preparation in 0.1% dose (w/w) relative to the rice overnight at room temperature. The soaked rice was transferred to a rice cooker and cooked. After cooking the cooked rice was stored at 4 or 20° C. At time 0 and after 1 and 2 days storage the texture of one intact cooked rice kernel was evaluated. Texture analysis was performed at room temperature, with 10 replications for each treatment. The results are shown in table 1a, table 1 b and table 2.

TABLE 1a

| Firmness (g) | 0 day | 1 day at 4° C. | 2 days at 4° C. |
|---|---|---|---|
| Control | 1000 ± 174a | 3459 ± 542a | 4175 ± 473a |
| 0.1% maltogenic alpha-amylase | 1114 ± 184a | 2729 ± 324b | 3555 ± 353b |

a, b: values with different letters are significantly different (p < 0.05).

TABLE 1b

| Firmness (g) | 0 day | 1 day at 20° C. | 2 days at 20° C. |
|---|---|---|---|
| Control | 1813 ± 548a | 3113 ± 954a | 2920 ± 702a |
| 0.1% maltogenic | 1543 ± 402a | 1804 ± 315b | 2020 ± 312b |
| alpha-amylase | | | |

a, b: values with different letters are significantly different (p < 0.05).

TABLE 2

| Firmness (g) | 0 day | 1 day at 4° C. | 2 days at 4° C. |
|---|---|---|---|
| Control | 2126 ± 197a | 3378 ± 558a | 3847 ± 353a |
| 0.1% maltogenic alpha-amylase | 2070 ± 231a | 2707 ± 155b | 2603 ± 366b |
| 0.1% branching enzyme | 2072 ± 190a | 2577 ± 412b | 2115 ± 280c |
| 0.1% branching enzyme + 0.1% | 2156 ± 279a | 2604 ± 449b | 2664 ± 205b |
| maltogenic alpha-amylase | | | |

a, b, c: values with different letters are significantly different (p < 0.05).

1-15. (canceled)

16. A method for preparing a cooked rice product having retarded staling which comprises the steps of:
(a) contacting rice with an aqueous enzyme solution comprising an enzyme selected from the group consisting of maltogenic alpha-amylase, branching enzyme and a mixture thereof; and
(b) cooking the rice.

17. The method of claim 16, wherein the contacting of the rice with the aqueous enzyme solution is performed during cooking.

18. The method of claim 16, wherein step (a) comprises soaking the rice in the aqueous enzyme solution before cooking.

19. The method of claim 18, wherein the soaking water is used for cooking the rice.

20. The method of claim 18, wherein soaking the rice in the aqueous enzyme solution is performed over a period of between 10 minutes and 24 hours.

21. The method of claim 18, wherein soaking the rice in the aqueous enzyme solution is performed over a period of between 1 and 12 hours.

22. The method of claim 18, wherein soaking the rice in the aqueous enzyme solution is performed at a temperature of between 5 and 30° C.

23. The method of claim 16, wherein the maltogenic alpha-amylase has an amino acid sequence that is at least 80% identical to the amino acid sequence in SEQ ID NO: 2.

24. The method of claim 16, wherein the branching enzyme has an amino acid sequence that is at least 80% identical to the amino acid sequence in to SEQ ID NO: 3.

25. The method of claim 16, wherein one or more other additional enzymes are present in the aqueous solution, wherein the other enzyme(s) is/are selected from the group consisting of amylase, glucanase, galactanase, mannanase, aminopeptidase, alpha-amylase, maltogenic alpha-amylase, beta-amylase, carboxypeptidase, catalase, chitinase, cutinase, cyclodextrin glycosyltransferase, deoxyribonuclease, esterase, alpha-galactosidase, beta-galactosidase, glucoamylase, alpha-glucosidase, beta-glucosidase, hemicellulase, haloperoxidase, invertase, laccase, lipase, phospholipase, mannosidase, oxidase, pectinolytic enzymes, peptidoglutaminase, peroxidase, phytase, glucose oxidase, polyphenoloxidase, protease, ribonuclease, trehalose and transglutaminase.

26. The method of claim 16, wherein the rice is any of Oryza sp. or Zizania sp.

27. The method of claim 16, wherein the rice is polished rice.

28. The method of claim 16, wherein the rice is parboiled rice.

29. The method of claim 16, wherein the reduction in hardness after 1 day and/or after 2 days is at least 5% relative to control.

30. A cooked rice product prepared by the method of claim 16.

31. A cooked rice product according to claim 30, which is a rice based ready prepared food.
